(19) United States
(12) Patent Application Publication
(10) Pub. No.: US 2013/0144248 A1
(43) Pub. Date: Jun. 6, 2013

(54) DEVICE TO INTRODUCE OR REMOVE A FLUID INTO OR OUT OF A CONTAINER

(71) Applicants: Harry Putter, Bad Salzschlirf (DE); Björn Lehmann, Bad Hersfeld (DE)

(72) Inventors: Harry Putter, Bad Salzschlirf (DE); Björn Lehmann, Bad Hersfeld (DE)

(73) Assignee: Fresenius Kabi Deutschland GmbH, Bad Homburg (DE)

(21) Appl. No.: 13/521,772

(22) PCT Filed: Feb. 18, 2011
(86) PCT No.: PCT/EP2011/052382

§ 371 Date: Feb. 12, 2013

Related U.S. Application Data
(60) Provisional application No. 61/306,621, filed on Feb. 22, 2010.

(30) Foreign Application Priority Data
Feb. 22, 2010 (EP) 10154304.9

(51) Int. Cl. A61J 1/14

(52) U.S. Cl. CPC A61J 1/1443
USPC 604/405

(57) ABSTRACT

The invention relates to a device for feeding a liquid into or removing a liquid from a receptacle, said device having a spike (1) and a housing (10, 20, 30) connected to the spike (1), wherein the spike (1) has a liquid channel (6) and a venting channel (7), and the housing (10, 20, 30) has a liquid filter chamber (24) connected to the liquid channel (6) and a venting filter chamber (11) connected to the venting channel (7). In order to achieve a larger filter surface while keeping the overall size of the structure to a minimum, the invention proposes that the liquid filter chamber (24) and the venting filter chamber (11) are arranged one above the other in the direction of a longitudinal axis (4) running along the spike (1).

This application concerns a device to introduce or remove a fluid into or out of a container with an extraction spike and a housing connected to the extraction spike, whereby the extraction spike has a fluid channel and a ventilation channel and there is in the housing a fluid filter chamber connected to the fluid channel to hold a fluid filter and a ventilation filter chamber connected to the ventilation channel to hold a ventilation filter.

Such a device, also called an extra-spike, is known from the state of the art. It is used in medical and laboratory technology for the removal of a fluid from a container, or to inject fluids into containers. Such fluids can include medications such as heparin or cytostatics or other pharmaceutically active substances. The spike is inserted into a seal in the corresponding container. The ventilation channel ensures that in the sealed position of the spike in the seal of the container, an air exchange takes place between the interior and the exterior of the container depending on the changing level of the fluid.

It is furthermore necessary for the air entering from outside into the container, or the air removed from the container when adding fluid, and if necessary the fluid introduced or removed, to be filtered. Filters ensure that undesired particles and other solids, including biological elements, are separated from the air or the fluid.

Publication DE 38 20 204 C2 discloses a device of this description in which a first chamber for a filter, connected to a fluid channel, and a second chamber of another filter, connected to the ventilation channel, are formed in a carrier plate. The first and the second chamber are located next to one another in the carrier plate, whereby one chamber has a C-shaped cross-section and the other chamber has a rectangular cross-section and one chamber surrounds the other.

The spike disclosed in publication EP 1 192 927 B1 also has a first filter chamber and a second filter chamber in a plate-shaped housing. The first filter chamber is provided with a fluid filter and the second filter chamber is provided with an air filter. These filter chambers are also located next to one another in the housing, whereby the fluid channel is connected to the first filter chamber and the air channel to the second filter chamber.

The disadvantage of the known solutions is that one must work with a very small filter surface, since the total cross-sectional width of the filter chambers next to one another determines the width of the extraction spike. Alternatively, the dimensions of the extraction spike must be increased, which is often undesirable and also increases material costs.

The task of this invention is thus to create a device for the introduction or removal of a fluid which provides a greater filter surface.

This task is solved by a device in which the fluid filter chamber and the ventilation filter chamber are arranged above one another (or in other words one after the other) along the longitudinal axis along the spike. This arrangement of fluid filter chamber and ventilation filter chamber also means that both chambers are arranged above one another or one after the other along the flow path of the fluid.

The device above according to the invention has the advantage that the entire width of the device and/or the housing is available to each filter as a filter surface, since due to the arrangement according to the invention of the fluid filter chamber and the ventilation filter chamber, each chamber can largely make use of the entire wide of the device and/or the housing. The particularly advantageous result is that filters with a smaller mesh width can be used, since due to the filter size even at a smaller mesh width sufficient air or fluid can still pass through. This can permit greater pressure stability against fluid breakthrough, so that contamination by emerging fluid is avoided without incurring greater penalties in performance.

Advantageously, the fluid filter chamber and the ventilation filter chamber can hereby largely be located in parallel to one another. This means that a center line through the fluid filter chamber perpendicular to the longitudinal axis of the extraction spike and a center line through the ventilation filter chamber perpendicular to the longitudinal axis of the extraction spike can run at an angle of at most 30°, preferably at most 10°, and particularly preferably roughly parallel to one another at an angle of at most 5°, from one another. The center line of the fluid filter chamber and the center line of the ventilation filter chamber each for axes that run along the largest extent of each chamber. The center line of each chamber can thereby also form a center line of the filter membrane located in each chamber.

In a particularly preferred embodiment of the present invention, the fluid channel is sealed from the ventilation filter chamber and runs through it, and/or the ventilation channel is sealed from the fluid filter chamber and runs through it. Alternatively, it is also possible for one of the channels to be routed past one of the filter chambers to its side.

In this invention, the term “route through” also means that a channel is routed past a given chamber, such that the chamber “through” which the channel is routed is only on one side of the channel. That means that the term “route through” in this invention should be understood in such a way that the channel that is routed through the chamber runs along the entire extent of the chamber in the direction of the longitudinal axis of the extraction spike. The extent of the chamber in the direction of the longitudinal axis of the spike can also be called the height of the chamber.

This embodiment, especially when the routing of the fluid channel through the ventilation filter chamber and/or the routing of the ventilation chamber through the fluid filter chamber is located roughly in the middle part of the housing, ensures the simple construction, which is also advantageous from the standpoint of production.

In an advantageous further refinement of the present invention, the ventilation filter chamber is shaped to hold a membrane filter, which at least has the shape of a segment of a circular ring. This structure of the ventilation filter chamber is very simple and is easy to implement in production. There are also advantages in the installation of such a device, because the arrangement of a circular ring-shaped membrane filter in a corresponding notch or depression of the housing can be carried out particularly exactly. According to the invention, a membrane filter must only largely have the shape of at least one segment of a circular ring, that is, also oval and/or offset-axis embodiments are possible. Moreover, the filter chamber can also have an inner opening, for example, that is oval and/or offset-axis.

It is furthermore preferred if in the ventilation filter chamber there is a ventilation filter, preferably a largely circular ring shaped membrane filter, and/or in the fluid filter chamber there is a fluid filter, preferably a largely circular membrane filter, which preferably are arranged concentrically. If filters are placed in both chambers, the fluid and the air can be filtered simultaneously. The concentric arrangement of the components of the device according to the invention improves automatic assembly, since the assembly direction remains constant. The mesh width of the ventilation filter membrane can be 0.02 μm to 3 μm, preferably 0.2 μm to 3 μm. The mesh width of the fluid filter membrane can be 1 μm to 15 μm, preferably 5 μm.

In another preferred embodiment, the top and/or bottom side of the fluid filter chamber and/or the top and/or bottom side of the ventilation filter chamber have support ribs. In a preferred embodiment, these are arranged in such a manner that any opposing support ribs in the fluid filter chamber or the ventilation filter chamber run slanted and/or offset from one another. This ensures that the tips or projections and/or valleys of the support ribs are located across from one another. This permits the entire filter size to be used optimally for filtration of the air and/or fluid and the dead space of the device is optimized so that nearly complete air or fluid exchange takes place.

Advantageously, the fluid chamber and/or the ventilation filter chamber furthermore has, in a refinement of the invention, on their top and/or bottom side, radially extended depressions. These depressions, formed as channels, run radially outwards from a central area in which the fluid or the air leaves that chamber through an opening, and cause an even distribution of the air and/or fluid over the entire surface of the corresponding filter.

It is furthermore advantageous if the housing is composed of at least two parts, preferably located one above the other, whereby particularly preferable are a housing bottom part, a housing middle part, and a housing top part. The ventilation filter chamber is preferably formed by the housing bottom part and the housing middle part and the fluid filter chamber is preferably formed by the housing middle part and the housing top part.

The modular construction of the housing from multiple parts makes it possible for different variants of the invented device, for example with a different structure for the spike or a modified connection housing with or without valves can easily be implemented without the entire device having to be modified. This saves manufacturing costs. The modular construction also ensures that different filters can be used as needed or that one filter, for example in the fluid filter chamber, can even be eliminated. These decisions can be made during the production process during the manufacture of the invented device, on a short-term basis. The manufacturer can therefore react quickly and flexibly to appropriate specifications by the customer.

Preferably, the first part, preferably the housing top part, is connected to the extraction spike and another part, preferably the housing top part, is connected to a connection housing. Particularly preferably, the first part, preferably the housing bottom part, is formed as a single piece with the extraction spike.

An advantageous control of the introduced or extracted fluid is achieved by providing the connection housing with a valve, preferably with a self-sealing valve plate and a valve actuator.

Production-specific advantages are also obtained if the housing is formed radially symmetrically, at least in segments.

To be able to use the invented device to introduce or remove cytostatics from/to the container as well, it is advantageous if the device is made of ABS (acrylnitrilbutadiene-styrol-copolymerisate) at least in the parts carrying fluid. As additional materials, the device according to the invention can use, for example, polystyrene, hard PVC (hard polyvinylchloride), PC (polycarbonate), SAN (styro-acrylnitril), polypropylene, and/or MABS (methyl-methacrylate-acrylnitril-butadiene-styrol).

Refinements, advantages, and application possibilities for the invention can also be found in the following description of an embodiment of the invention and in the figures. All features described and/or shown in the figures are themselves or in arbitrary combination the object of this invention, even independently of their combination in the claims or their interdependence.

The figures show schematic diagrams of the following:

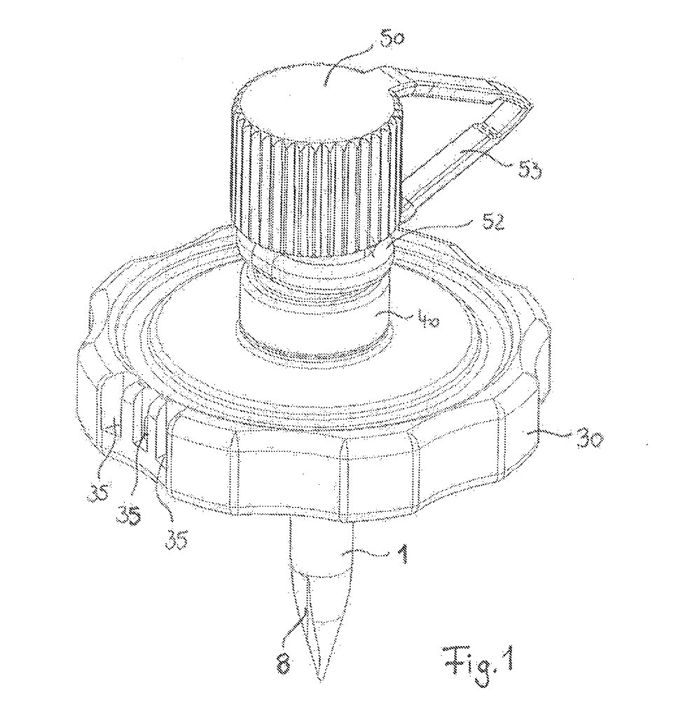

FIG. 1 shows the device according to the invention in a perspective view from the top;

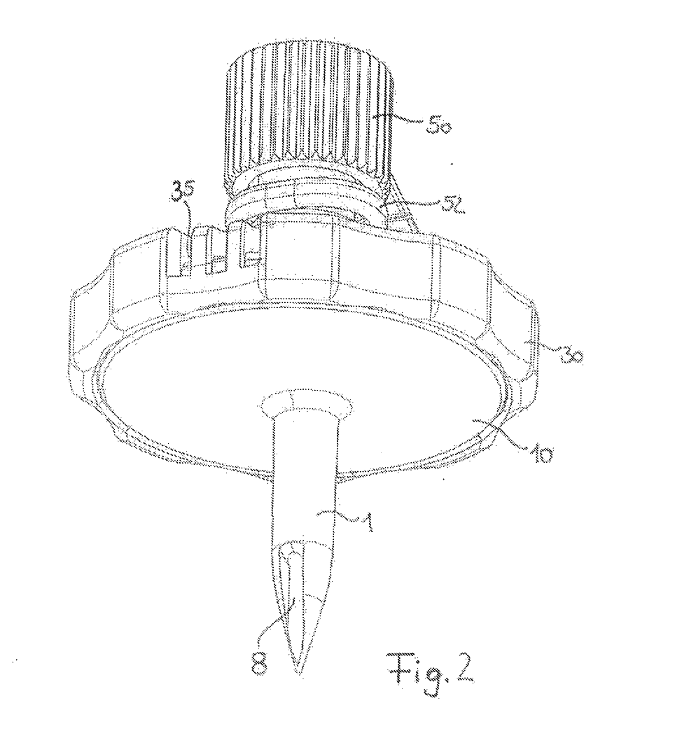

FIG. 2 shows the device according to the invention in FIG. 1 in a perspective view from the bottom;

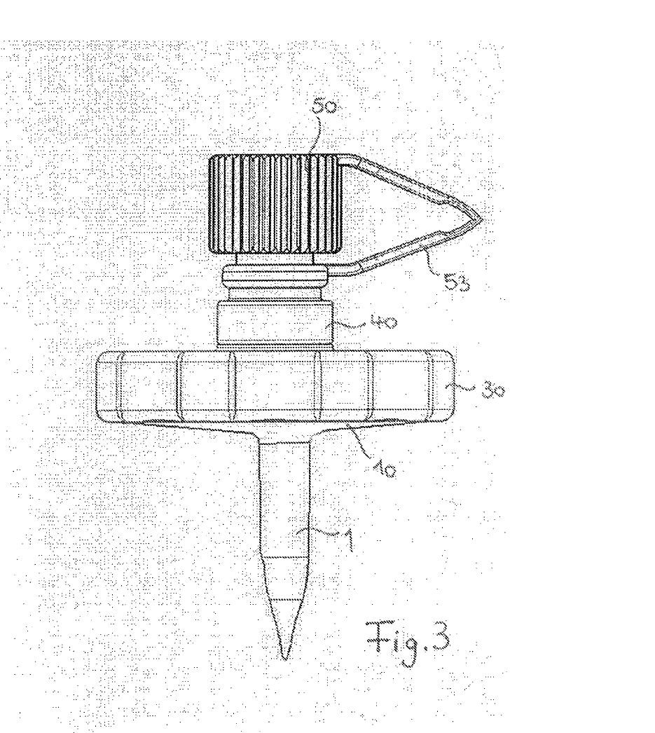

FIG. 3 shows the device according to the invention in FIG. 1 in a first view from the side;

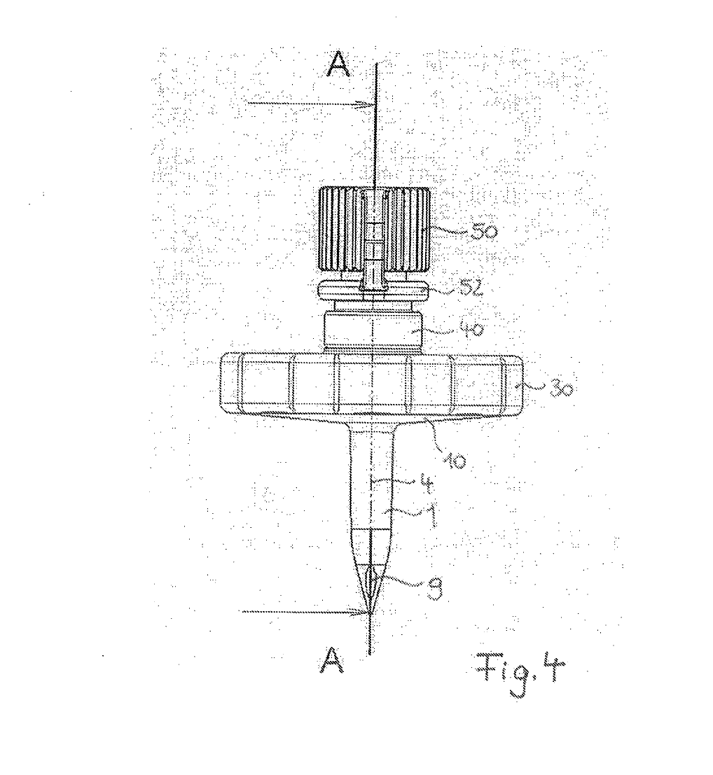

FIG. 4 shows the device in FIG. 1 in a second view from the side;

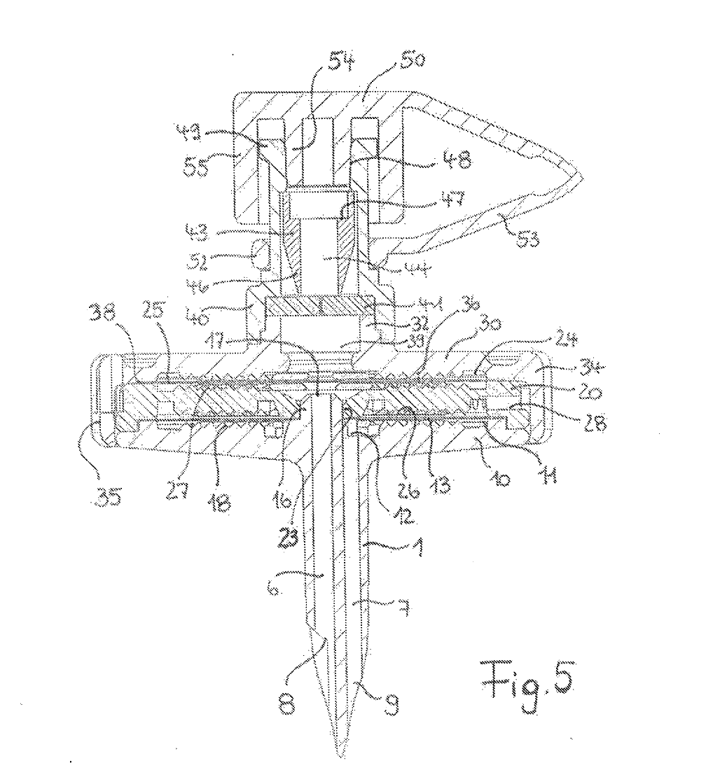

FIG. 5 shows the device in FIG. 1 in a cross-sectional view along line A-A (see FIG. 4) with filters;

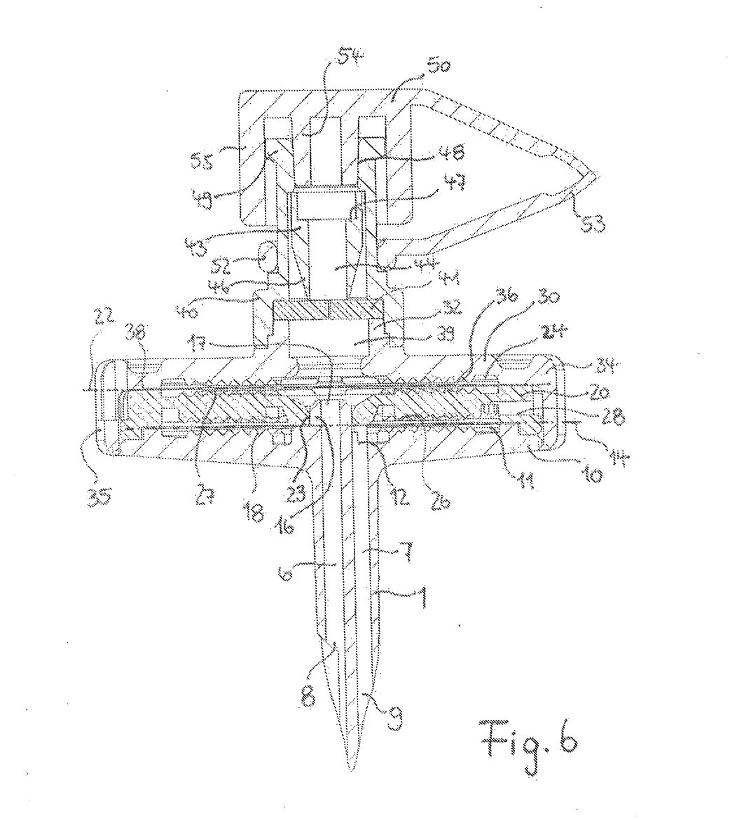

FIG. 6 shows the device in FIG. 5 without a filter;

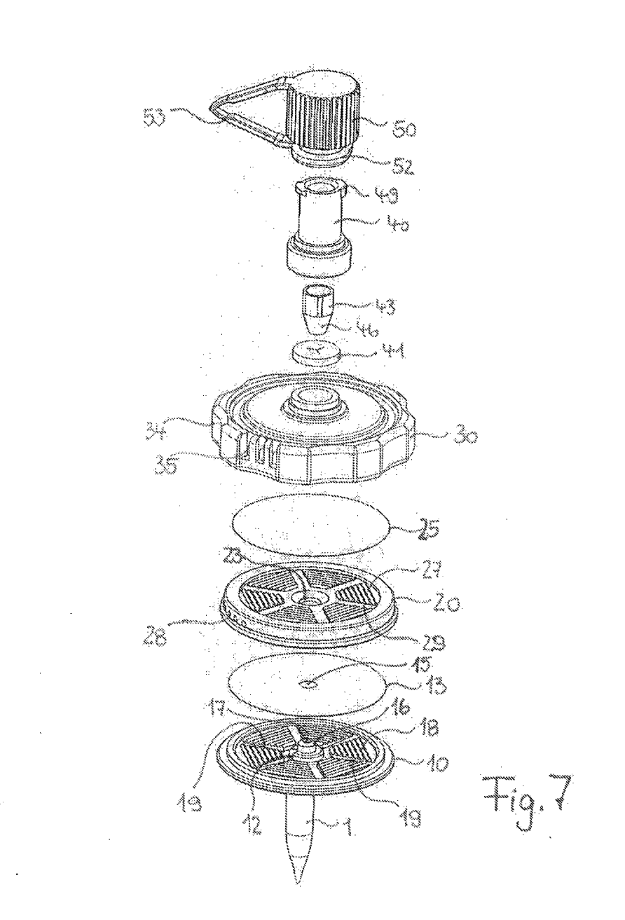

FIG. 7 shows an exploded view of the device according to the invention shown in FIG. 1 in a perspective view from the top, and

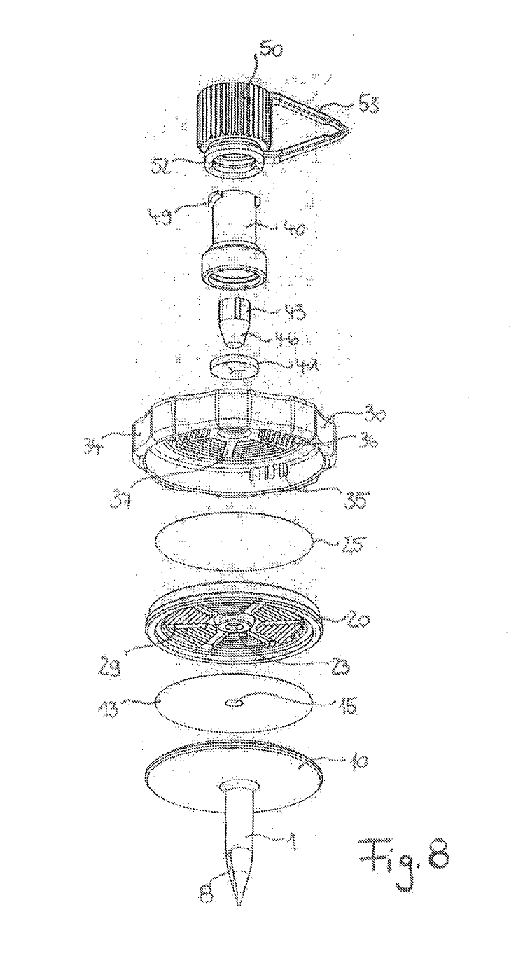

FIG. 8 shows an exploded view of the device according to the invention shown in FIG. 1 in a perspective view from the bottom.

The invented device to introduce or remove a fluid into or out of a container is explained below in terms of its function as a device for the removal of a fluid and in the description below is called an extraction spike. With the same structure, the extraction spike can also be used as a device to introduce fluid into a container.

The extraction spike has at its lower end a spike 1 with which it can be inserted into the seal of a container, not shown.

The housing comprises a housing bottom part 10, a housing middle part 20, and a housing upper part 30, which are arranged above one another along the direction of a longitudinal axis 4 extending along the spike 1. The spike 1 is formed as a single piece with the housing bottom part 10. On housing top part 30 there is a connection housing 40 fastened whose upper end can be closed with a cap 50. In addition the housing top part 30 and the connection housing 40 can also be formed as a single piece, particularly for embodiments without the valve described in more detail below.

The housing bottom part 10 and the housing middle part 20, the housing middle part 20 and the housing top part 30, and the housing top part 30 and the connection housing 40 are preferably welded, glue, or otherwise fastened together with a seal. Here, the guiding areas shown in FIG. 5 can be provided between the housing bottom part 10 and the housing middle part 20.

In parallel with the longitudinal axis 4 of the spike 1, a fluid channel 6 and a ventilation channel 7 run within it. The fluid channel 6 ends at the end of the spike 1 across from the housing in a fluid intake opening 8 and the ventilation channel 7 ends at the same end of the spike 1 in an air outlet opening 9.

Between the housing bottom part 10 and the housing middle part 20 there is a ventilation filter chamber 11 that serves to hold a circular ring shaped ventilation filter membrane 13 with a mesh width from 0.02 μm to 3 μm. With its penetrating circular opening 15, the ventilation filter membrane 13 is placed around a cylindrical projecting segment 16 of the housing bottom part 10. This can permit exact placement of the ventilation filter membrane. The ventilation channel 7 ends at the top side of the housing bottom part 10 with an opening 12, so that the ventilation channel 7 is connected to the ventilation filter chamber 13.

The fluid channel 6 extends in the housing bottom part 10 into the cylindrically projecting segment 16 which projects upwards from the housing bottom part 10. The cylindrical segment 16 is sealed or welded into a corresponding penetrating opening 23 of the housing middle part 20. By means of the cylindrical segment 16, fluid channel 6 is routed through the ventilation filter chamber 11, so that it is sealed away from the ventilation filter chamber 11.

The fluid channel 6 ends at the upper end across from the spike 1, and/or at the end of the cylindrical segment 16 with a fluid outlet opening 16 which is connected to a fluid filter chamber 24. The fluid filter chamber 24 is formed between the housing middle part 20 and the housing upper part 30. In the fluid filter chamber 24 there is a circular fluid filter membrane 25 with a mesh width from 1 μm to 15 μm. The fluid filter membrane can, however, be eliminated for certain applications of the extraction spike, for example if there is a risk of retaining the active ingredients of a medication. The fluid filter membrane has the task of filtering solids out of the fluid.

The fluid is forced through the fluid inlet opening 8 formed in the spike into the fluid channel 6 of the spike 1 and then passes through opening 17 in cylindrical segment 16 into the fluid filter chamber 24. The fluid filter chamber 24 is connected through a penetrating channel 39 of housing upper part 30 to a penetrating channel 44 of the connection housing 40, which has a valve as described below. The fluid thus passes through the fluid filter membrane 25 to reach channel 44. In the upper end of the penetrating channel 44 of the connection housing 40, there can for example be a needle (not shown) which accepts the fluid. The channels 39 and 44 run along longitudinal axis 4. Alternatively according to one variant of the invention there can be a redirection in the area of the chamber above the fluid filter, that is, there is no penetrating channel but rather a strike plate.

The housing upper part 30 has, in the vicinity of its lateral edge 34, three penetrating ventilation openings 35 through which the air is sucked from outside into the extraction spike once an underpressure results in the container into which the extraction spike has been inserted with a seal due to the removal of fluid. The air passes through three additional lateral and penetrating air intake openings 28 into the housing middle part 20 and through the ventilation filter chamber 11 into the ventilation channel 7 and passes back out through the air outlet opening 9 into the container (not shown). However, the invention is not restricted to this specific arrangement of the location and type of housing opening; instead, the air intake and outlet openings can also be placed at other points on the housing. In the ventilation filter chamber 11, the incoming air is filtered through a ventilation filter membrane 13, so that no solids such as particles or bacteria that are larger than the mesh width of the ventilation filter 13 can penetrate into the container.

On the bottom side of ventilation filter chamber 11, the housing bottom part 10 has support ribs 18 which primarily have a triangular cross-section, whereby other cross-sectional shapes are also plausible. Analogous support ribs 26, 27, and 36 are also formed on the top side of the ventilation filter chamber 11 on the housing middle part 20, on the bottom side of the fluid filter chamber 24 also on the housing middle part 20 and on the top side of the fluid filter chamber 24 on the housing top part 30. In the vicinity of the support ribs 18, 26, 27, 36, each filter membrane 13, 25 is held by the tips of the support ribs 18, 26, 27, 36.

In the ventilation filter chamber 11, furthermore, on the top side of the housing bottom part 10 and on the bottom side of the housing middle part, there are radially extending depressions 19, 29 in the form of channels provided, which extend outwards from the vicinity of the cylindrical segment 16 located roughly in the middle. Analogous depressions 29, 37 are also provided in the fluid filter chamber 24 on the top side of the housing middle part 20 and the bottom side of the housing top part 30. The depressions 19, 29, 37 ensure even distribution of the air and/or fluid over the entire area of the ventilation filter membrane 13 and the fluid filter membrane 25. They form channels between the support ribs 18, 26, 27, 36.

Both the ventilation filter membrane 13 as well as the fluid filter membrane 25 extend over nearly the entire width of the housing. As a result, in comparison with the state of the art explained above there is a large area for filtration of the air and/or the fluid with minimum size of the extraction spike. Consequently, filters with a smaller mesh width, for example with a mesh width of 0.2 μm instead of 3 μm, can be used in order to ensure pressure stability against fluid emerging in case of improper use.

The small size of the extraction spike according to the invention is also achieved in that a center line 14 of the ventilation filter chamber 11 and a center line 22 of the fluid filter chamber 24 are parallel to one another and thus together occupy a minimum volume. The center line 14 of the ventilation filter chamber 11 and the center line 22 of the fluid filter chamber 24 run perpendicular to the longitudinal axis 4 and simultaneously form a center line of the ventilation filter membrane 13 and a center line of the fluid filter membrane 25.

The housing upper part 30 is formed in its upper section across from the spike 1 as a connector 32 with which the connection housing 40, for example using a welded or glued connection is connected to the housing upper part 30, or is formed as a single piece. Above the connector 32 of the housing upper part 30 there is a valve plate 41 located in channel 44 of connection housing 40 which consists of an elastomer material and is clamped between a projection in the interior surface of the connection housing 40 and the face of the connector 32. The valve plate 41 has a slitted or opening structure. It is self-sealing, that is, without any mechanical actuation by connection to the connector, it assumes the closed position shown in FIGS. 5 and 6. The valve actuator 43 located above the valve plate 41 is a tube-shaped part with a conical stump 46 provided on the lower end. On the interior surface of the valve actuator 43 there is a projection 47 extending inwards. Upon insertion, for example, of a needle into the connection housing 40, the penetrating part of the needle strikes the projection 47 of the valve actuator 43, which then is pushed downwards into the connection housing 40. By means of the force thus generated, valve plate 41 is pushed upwards and forcibly held in the open position as long as the penetrating part of the needle exerts a downwards force on projection 47. Once this is no longer the case, the valve actuator 43 returns to the starting position due to the spring action of the elastic valve plate 41, and the valve closes by itself.

The cap 50 is fastened to the connection housing 40 by means of a ring 52 around the neck of the connection housing 40. The ring 52 is connected to a jointed arm 53 that guides the cap 50 when opening or closing, whereby unintentional spraying of the fluid is avoided. The cap 50 furthermore has a cylindrical closure part 54 which penetrates into the interior cone 48 of the top end of the connection housing 40 and closes and seals it. A external cylindrical closure part 55 also provided on the cap 50 surrounds the projections 49 on the top end of the connection housing 40. The projections 49 simultaneously prevent the ring 52 from slipping off the neck of the connection housing 40.

In particular from FIGS. 7 and 8 it can be seen that the parts of the invented extraction spike are largely arranged concentrically to one another. This arrangement permits simple, exact installation of the individual parts in the manufacturing process, so that production is cost-effective.

The embodiment mentioned above includes variants in which the ventilation filter chamber 11 is located below the fluid filter chamber 25, when the extraction spike is oriented in the manner shown in FIGS. 1 through 8. However, it is also possible to place the fluid filter chamber below the ventilation filter chamber. In this case, both the fluid channel must be routed through the ventilation filter chamber as well as the ventilation channel being routed through the fluid filter chamber in the sense of this invention. This solution is therefore more costly than the variant shown in the figures, but is still covered by this invention.

In the embodiment shown in the figures, the axis of the spike 1 is not identical to the rotational axis of the other components. Rather, these components all lie on an axis aligned with the axis of the fluid channel 6, while the spike 1 is asymmetrically located with respect to that axis. In principle, however, the fluid channel 6 can also be offset from the perspective of the other components, so that their longitudinal axes, for example, coincide with that of the extraction spike 1.

### REFERENCE LIST

1 Spike

4 Longitudinal axis

6 Fluid channel

7 Ventilation channel

8 Fluid intake opening

9 Air outlet opening

10 Housing bottom part

11 Ventilation filter chamber

12 Opening

13 Ventilation filter membrane

14 Center line

15 Opening

16 Cylindrical segment

17 Fluid outlet opening

18 Support rib

19 Depression

20 Housing middle part

22 Center line

23 Opening

24 Fluid filter chamber

25 Fluid filter membrane

26 Support rib

27 Support rib

28 Air intake opening

29 Depression

30 Housing upper part

32 Connectors

34 Edge

35 Ventilation opening

36 Support rib

37 Depression

38 Circular depression

39 Channel

40 Connection housing

41 Valve plate

43 Valve actuator

44 Channel

46 Conical stub

47 Projection

48 Interior cone

49 Projection

50 Cap

52 Ring

53 Jointed arm

54 Interior cylindrical closure part

55 Exterior cylindrical closure part

1. Device for the introduction or removal of a fluid into or out of a container with an extraction spike and a housing connected to the extraction spike, whereby
The extraction spike has a fluid channel and a ventilation channel and
The housing has a fluid filter chamber connected to the fluid channel and a ventilation filter chamber connected to the ventilation channel,
whereby the fluid filter chamber and the ventilation filter chamber are arranged above one another along a longitudinal axis along the extraction spike, wherein
the fluid filter chamber and the ventilation filter chamber are arranged largely in parallel to one another and a ventilation filter is located in the ventilation filter chamber in the form of a largely circular ring-shaped membrane filter and a fluid filter is located in the fluid filter chamber in the form of a largely circular membrane filter.

2. Device according to claim 1, wherein the fluid channel is sealed off from the ventilation filter chamber and runs through it, and/or the ventilation channel is sealed off from the fluid filter chamber and runs through it, or is routed past it to one side.

3. Device according to claim 1, wherein the ventilation filter chamber is designed to hold a membrane filter that largely has the shape of at least a segment of a circular ring.

4. Device according to claim 1, wherein the ventilation filter and the fluid filter are arranged concentrically to one another.

5. Device according to claim 1, wherein the top and/or bottom side of the fluid filter chamber and/or the top and/or bottom side of the ventilation filter chamber each have support ribs that are preferably arranged in such a way that any opposing support ribs of the fluid filter chamber or of the ventilation filter chamber are oriented slanted and/or offset from one another.

6. Device according to claim 1, wherein the fluid filter chamber and/or the ventilation filter chamber each have depressions running radially on their top and/or bottom sides.

7. Device according to claim 1, wherein the housing is composed of at least two parts, preferably oriented above one another, whereby a housing bottom part, a housing middle part, and a housing top part are present.

8. Device according to claim 7, wherein the fluid channel and/or the ventilation channel runs in a projecting cylindrical segment of a first part of the housing, whereby the projecting cylindrical segment runs through the ventilation filter chamber and is located and sealed within a corresponding opening in a second part of the housing, preferably the housing middle part.

9. Device according to claim 7, wherein the first part, is connected to the extraction spike and a second part, is connected to a connection housing.

10. Device according to claim 9, wherein the connection housing has a valve, and a valve actuator.

11. Device according to claim 1, wherein the housing is radially symmetric in shape, at least in segments.

12. Device according to claim 1, wherein the device is made of ABS or MABS at least in the parts that carry fluid.
